(19) United States
(12) Patent Application Publication
(10) Pub. No.: US 2024/0208866 A1
(43) Pub. Date: Jun. 27, 2024

(54) CONCRETE COMPOSITION FOR RAILWAY FOUNDATIONS

(71) Applicant: OVERAIL S.R.L., Roma (RM) (IT)

(72) Inventors: Umberto PETRUCCI, Roma (RM) (IT); Vito ALUNNO ROSSETTI, Ariccia (RM) (IT)

(73) Assignee: OVERAIL S.R.L., Roma (RM) (IT)

(21) Appl. No.: 18/553,781

(22) PCT Filed: Mar. 5, 2021
(86) PCT No.: PCT/IB2021/051856

§ 371 Date: Oct. 3, 2023

(51) Int. Cl. C04B 28/06; B28C 5/16; B28C 7/02; C04B 24/06; C04B 111/00

(52) U.S. Cl. CPC C04B 28/065; B28C 5/168; B28C 7/02; C04B 24/06; C04B 2111/00698

(57) ABSTRACT

The present invention relates to a concrete containing a binding blend of Portland cement and calcium sulphoaluminate-based cement; the use of the concrete for implementing under-rail railway foundations, as well as a method for the production of the concrete.

The present invention relates to a concrete comprising a binding blend of Portland cement and calcium sulphoaluminate-based cement; the use of said concrete for implementing under-rail railway foundations, as well as a method for the production of said concrete.

### STATE OR ART

Formulations for cement-based concrete are widely used in the construction and urban planning sector for the implementation of structural materials. Depending upon the composition, these formulations can vary in terms of durability and workability.

An important disadvantage of the usual cement blends is that of a stiffening requiring several hours, which hinders in-line working in short time allowing complete interventions limited to night time, for reasons of traffic interruption.

A second disadvantage is represented by the tendency to formation of cracks in the stiffened state, due to thermal phenomena or hygrometric shrinkage. In the latter case, the expansion capability of the used cement blend can have a significative impact to reduce the shrinkage.

In this context then the need is much felt for developing formulations for concrete allowing to overcome the drawbacks of the compositions known in the state of art.

### SUMMARY OF THE INVENTION

The authors of the present invention have developed a concrete particularly suitable for several applications in the field of the constructions, and in particular for implementing foundations for under-rail railway slabs (plates, or sheets).

The concrete set forth by the present invention is of self-levelling type and it is produced by using normal Portland cement (PC) with the addition of calcium sulphoaluminate-based cement (with formula 4CaO·3Al₂O₃·SO₃, abbreviated as CSA). These are accompanied by compounds generally existing in the Portland cement (calcium sulphate CaSO₄·2H₂O) and calcium hydroxide (Ca(OH)₂).

CSA matrix, after combination with mix water, results to be much resistant thanks to the packaging of needle-like crystals of Ettringite (chemically, a trisulphoaluminate tricalcium hydrate: 3CaO·Al₂O₃·3CaSO₄·32H₂O), whose interweaving creates a mechanical interlock which offers a better resistance to the possible propagation of cracks (crazing).

PC matrix is different since the resistance arises from the attraction forces due to capillary phenomena, of Van Der Waals, with chemical bond and others, between the thin plates or foils of C—S—H gel, formed by poorly crystalline calcium hydrated silicates, produced by the cement hydration reactions, in particular by the hydration of the silicates existing in the clinker.

Sulphoaluminous clinker, Portland cement and micronized calcium sulphate, dosed in suitable percentage, in case together with fluidifying and retardant additives, allow to obtain formulations the setting time thereof can be adjusted by varying the mixing ratio, even depending upon the environmental temperature. Thanks to optimization of the ratio between PC and CSA, the concrete according to the present invention is characterized by a quick development of the performances, by controlled shrinkage and optimum resistance to the aggressive environments, in particular to the sulphatic ones.

Advantageously, the concrete developed by the inventors is characterized by a shrinkage due to limited drying and by a quick development of the resistances. The product, even if it guarantees a workability preservation time of 30 minutes, in fact, is able to develop resistances higher than 5 MPa within two hours from casting. Moreover, the CSA-based concrete is able to develop a moderate hydration heat and has a reduced carbon-footprint.

Therefore, the present invention refers to:
Concrete comprising a binding blend of Portland cement and calcium sulphoaluminate-based cement (CSA);
A process for the production of concrete as defined in the present description and in the claims, comprising at least a hydration passage of a blend of Portland cement and calcium sulphoaluminate-based cement (CSA).
The use of concrete as defined in the present description and in the claims, for implementing the foundation of railway slabs, in particular prefabricated railway slabs.
A process for implementing the foundation of railway slabs comprising at least the following passages:
preparation of concrete according to any one of the herein described embodiments;
casting of said concrete between the intrados surface of said slabs and a platform plane.

### Glossary

In the present description, under the term “clinker” the base component for the production of cement is meant, so called from the name of the kiln in which the backing process takes place. The raw materials used for the production of clinker are minerals containing silicon oxide (SiO₂), aluminium oxide (Al₂O₃), iron oxide (Fe₂O₃), generally existing in clay, calcium oxide (CaO), and magnesium oxide existing in carbonate rocks.

### DETAILED DESCRIPTION

The present invention relates to a concrete particularly advantageous in terms of rheological and mechanical properties, in particular characterized by a shrinkage due to limited drying, by a quick development of the resistances, as well as by an excellent resistance to aggressive environments, for example the sulphate environments.

Therefore, a first aspect of the present invention relates to a concrete comprising a binding blend of Portland cement and a calcium sulphoaluminate-based cement (CSA).

The combination of Portland cement and CSA cement represents the “blend of the binder”, that is the concrete element which, by reacting with water and by hardening, will create the characteristic monolithic product having hard consistency.

The Portland cement is the product of an industrial process mainly consisting of baking in kiln natural earth (clinker) containing a blend of silicates and aluminates, and in the subsequent mill grinding in presence of small amounts (generally between 4 and 8%) of chalk (CaSO₄ 2H₂O) or anhydrite (CaSO₄).

Several types of Portland cement can be used for implementing concrete according to the present invention, which include traditional Portland cement and/or limestone Portland cement.

In the reaction with C₄A₃S (main constituent of CSA cement), the calcium hydroxide is required. To this purpose it is possible using Portland cement or a derivative thereof, for example CEM II limestone cement or other derived Portland cements provided that they can provide such hydroxide to the extent required.

Under the term “calcium sulphoaluminate-based cement” (CSA), in the present description, cement is meant, comprising or consisting of calcium sulphoaluminate clinker, or a cement wherein the active mineralogical phase from the hydraulic point of view is a phase consisting of calcium sulphoaluminate synthetized starting from raw materials such as bauxite, anhydrite and limestone. The CSA cement used for the preparation of concrete according to the present invention can be obtained by using any one of the methods known in the art. By pure way of example, the CSA cement can be produced by means of baking of bauxite, anhydrite and limestone in rotating kilns at the temperature of about 1300° C. The main constituents of this cement are: Dicalcium Silicate (CaO SiO₂), Dihydrate chalk (CaSO₄ 2H₂O) and/or Anhydrite (CaSO₄), Ye'elimite (4CaO·3Al₂O₃·CaSO₄). The content of Ye'elimite in CSA cement can vary from 35 to 65%.

The concrete set forth by the present invention comprises dicalcium silicate (CaO·SiO₂ or C₂S) and calcium sulphate in one of the anhydrous, hemihydrate or bihydrate forms, or combinations thereof.

The hydration of the binding blend of Portland cement and CSA cement involves the formation of ettringite, that is trisulphoaluminatetricalcium hydrate (3CaO Al₂O₃ 3CaSO₄ 32H₂O). The packaging of needle-like crystals of ettringite forming after the combination of CSA matrix with mixing water, is capable of forming a mechanical interlocking which offers a better resistance to the possible propagation of cracks (crazings).

As previously mentioned, in the matrix of Portland cement, the resistance instead originates from the attraction forces due to capillary phenomena, of Van Der Waals, of chemical bond and others, between the thin plates or foils of C—S—H gel, formed by poorly crystalline calcium hydrated silicates, produced by the hydration reactions of cement compounds, in particular by the hydration of the dicalcium and tricalcium silicates existing in the clinker.

In a preferred embodiment according to the present invention, the concrete is characterized by a weight ratio of Portland cement with respect to the calcium sulphoaluminate-based cement varying from 90:10 to 65:35, preferably said ratio is equal to 75:25 or equal to 80:20.

An embodiment of the present invention in particular relates to a concrete wherein said Portland cement is present in an amount comprised between 65% and 90% by weight, and said calcium sulphoaluminate-based cement is present in an amount comprised between 10% and 35% by weight with respect to the total weight of blend of Portland cement and CSA cement.

In a preferred embodiment, said Portland cement is present in an amount comprised between 75% and 80% by weight, and said calcium sulphoaluminate-based cement is present in an amount comprised between 20% and 25% by weight with respect to the total weight of blend of Portland cement and CSA cement.

The binding blend of Portland cement and CSA cement has a total weight comprised between 250 and 500 kg/m³, preferably equal to 400 kg/m³.

The concrete according to the present invention, preferably comprising a blend of Portland cement and CSA cement according to any one of the previously described embodiments, is preferably characterized by a volume mass comprised between 2250 and 2400 kg/m³.

According to an aspect of the present invention, the concrete comprises, apart from the binder blend according to any one of the previously described embodiments, even one or more additives selected among: fluidifying agents of various effect level, for example normal fluidifying agents, superfluidifying agents or hyperfluidifying agents, (suitable for the summer or winter season) retardant, accelerating agents, deaerating agents, expanding agents, shrinkage reducers.

Not limiting examples of retardant and accelerating additives include the citric acid, the tartaric acid, the lithium carbonate and the calcium oxide.

Preferably, the concrete according to any one of the previously described embodiments comprises citric acid.

The citric acid can be used in the concrete in an amount comprised between 0.1 and 0.5% by weight with respect to the total weight of the binding blend, preferably in an amount equal to 0.3%.

The use in the concrete of accelerating agents containing chlorides to the extent higher than 0.1% with respect to the total weight of cement is excluded.

The concrete of the invention further comprises a blend of inert materials, more properly known as “aggregates”, that is natural granular material of mineral origin subjected to mechanical processing thereafter, depending upon the size, the fine aggregate (whose maximum size is ≤ 4 mm) and the big aggregate (whose upper size is >4 mm) are obtained, commonly used in the constructions and the properties thereof are specified in UNI EN 12620. The aggregates constitute the backbone of the conglomerate, the cohesion thereof is guaranteed by the cement-based binder blend.

Aggregates with reduced volume mass can also be used, such as for example expanded clay, vermiculite and perlite, and/or combinations thereof.

The quality and the granulometric composition of the aggregates are important for the good success of the final conglomerate.

Aggregates suitable to be used for the production of concrete according to the present invention are the aggregates commonly used for the constructions made of reinforced concrete, then having a typical maximum diameter of the aggregates commonly used for such constructions, provided that they are capable of providing a self-levelling concrete to be cast in a space with limited height.

The blend of aggregates usable for the preparation of the invention concrete preferably consists of the fine aggregate, in particular sand, and of the big aggregate, 5 designated as “aggregate 4/8” according to the standard UNI EN 12620 (or an aggregate with the percentage passing by mass from 0 to the 20% at the sieve of 4 mm and from 80 to 99% at the sieve of 8 mm).

According to an aspect of the present invention, said blend of aggregates comprises the big aggregate, in particular aggregate 4/8, in an amount equal to 45% by weight with respect to the total weight of the blend of aggregates and comprises sand in an amount equal to 55% by weight with respect to the total weight of the blend of aggregates.

Even the filler, a very thin material, most part thereof passes at the sieve 0.063 mm, can be added in an amount varying between 50 and 170 kg/m³, preferably equaling to 150 kg/m³. The presence of filler is useful to adjust the technological properties of the blend.

According to an additional aspect of the invention, the concrete according to any one of the herein described embodiments comprises water in an amount comprised between 140 and 190 l/m³.

A preferred embodiment of the present invention relates to a concrete consisting of:
Portland cement: 70%
CSA: 30%
Total binder 400 kg/m³
Water 176 l/m³
Superfluidifying additive 2%
Retardant (Citric acid) 0.3%
Filler 150 kg/m³
Sand 55%
Aggregate 4/8, 45%

A second preferred embodiment of the present invention relates to a concrete consisting of:
Cement Portland: 75%
CSA: 25%
Total binder 400 kg/m³
Water 176 l/m³
Superfluidifying additive 2%
Retardant (Citric acid) 0.3%
Filler 150 kg/m³
Sand 55%
Aggregate 4/8, 45%

A third preferred embodiment of the present invention relates to a concrete consisting of:
Cement Portland: 80%
CSA: 20%
Total binder 400 kg/m³
Water 176 l/m³
Superfluidifying additive 2%
Retardant (Citric acid) 0.3%
Filler 150 kg/m³
Sand 55%
Aggregate 4/8, 45%

As previously mentioned, the concrete set forth by the invention is of “self-levelling” type, also defined as self-compacting (Self compacting concrete or SCC), it is namely a cement conglomerate which apart from having a high fluidity, in the fresh state, has even a high resistance to segregation since it results to be capable of compacting due to the effect of its own weight without the supply of external energy (mechanical vibration).

The rheological and/or mechanical properties of concrete set forth by the invention can be determined and/or quantified by using one/or any one of the standard techniques and methods known in the field. Some of the most widespread equipment for evaluating the rheological properties of the self-levelling concretes, recognized by UNI EN Standard and by the European Guidelines, include Abrams cone (Slump-flow), V-funnel like shape (V-funnel), or the L-like box (L-box).

Abrams cone is generally used to perform a spreading test and a test of the concrete spreading time. The test consists in inserting the concrete within the Abrams cone rested upon a smooth plate with a plane surface and, subsequently, in lifting it by letting the concrete to flow, actuating a chronometer when the same is lifted.

The test by means of Abrams cone allows to determine:
the “slump-flow” (d_{f}), or the final diameter of the concrete cake after the same has ceased to flow, which is the average of two orthogonally measured diameters;
the time required so that the concrete cake reaches a diameter (spreading) equal to 500 mm (t₅₀₀).

The slump-flow measurement is proportional to the material flowing capability in absence of obstacles: the higher is the value of d_{f}, the higher is the material deformability, i.e. its capability of reaching areas distant from the point of inserting the concrete into the formwork. Based upon the value of d_{f} the European Guidelines and UNI EN 206-9 standard, with the test method of UNI EN 12350-8 standard, divide the self-levelling concretes, relatively to the slump-flow measure, into three classes:
SF1, spreading diameter in mm: 550-650;
SF2, spreading diameter in mm: 660-750;
SF3, spreading diameter in mm: 760-850;

According to an aspect of the invention, the concrete set forth by the invention has a class of Slump Flow of SF1/SF2 type, a flowing time t₅₀₀ comprised between 10 and 15 seconds and a spreading diameter comprised between 550 and 750 mm.

The concrete set forth by the invention is further characterized by a quick development of the resistance. The resistance development can be measured according to UNI EN 12390 standard.

Advantageously, the concrete according to any one of the previously described embodiments is capable of developing resistances higher than 5 MPa within two hours from casting and it guarantees a workability of at least thirty minutes.

Thanks to its optimum rheological and mechanical properties, the concrete set forth by the present description is suitable to implement most part of the conventional applications, such as the implementation of vertical structures, supporting walls, pillars. The authors of the present invention have found that the concrete of the present invention results to be particularly suitable for laying foundation slabs and in particular for laying prefabricated railway slabs (or plates), i.e. for the implementation of the foundation of prefabricated railway slabs.

The present invention, then, further relates to the use of a concrete according to any one of the previously described embodiments for implementing the foundation of railway slabs, such as prefabricated railway slabs.

The foundation performs the function of dividing and transmitting the loads and of recovering the irregularities of the resting plane. In the procedure for laying the railway slabs, the concrete foundation casting is performed in the tract in which the slabs are laid and adjusted plano-altimetrically. In particular, the casting of said concrete is performed between the intrados surface of said slabs and a platform plane. The optimum rheological properties of the concrete set forth by the invention allow it to fill-in the space between intrados slab and resting plane and then to flow between the two horizontal surfaces.

The present invention further relates to a process for the concrete production according to any one of the previously described embodiments, comprising at least a passage of hydrating a blend of Portland cement and CSA cement.

Said passage can be performed by using any one of the techniques and/or of the procedures known to a person skilled in the field.

Preferably, said production process further provides a passage for adding citric acid to the cement blend, in an amount preferably equal to 0.3% with respect to the total weight of the binding blend, useful to modulate the setting time of the blend.

According to an aspect of the present invention, the herein described concrete production process can include the use of an automatic concreting system, equipped with inert storage hoppers provided with weighing electronic balances, cement storage silos provided with electronic balances, mixer provided with waiting hopper with horizontal agitator against sedimentation of grout, conveyor belt, water dosing system, additive dosing system. For casting a helical cavity pump with progressive adjustment of range and pressure can be used.

According to an aspect of the invention, a concreting train, equipped for the concrete production as well as for casting the foundation supporting the slabs, could be used.

According to an aspect of the invention, the concreting system can be provided with electric-electronic apparatus for commanding and controlling manually and automatically (even remotely) the system as well for recording all parameters necessary for the product qualitative control.

According to an aspect of the present invention the concreting train can be provided with a system for managing and controlling the temperature of Overcrete product components.

According an aspect of the present invention heating serpentines within casting can be used.

The present invention also relates to a process for laying tracks for ballastless railway and tramway lines on prefabricated slabs comprising at least a passage of casting a foundation made of concrete between the intrados surface of the slabs and a platform plane, wherein said concrete is any one of the previously described concretes.

The invention further relates to a process for implementing the foundation of railway slabs comprising at least the following passages:
preparation of concrete according to any one of the previously described embodiments; and
casting of said concrete between the intrados surface of said slabs and a platform plane.

In any point of the description and claims the term “comprising” can be replaced by the term “consisting of”.

Examples are reported herebelow, having the purpose of better illustrating the compositions described in the present description, such examples are in no way to be considered as a limitation of the previous description and of the following claims.

### EXAMPLES

Examples of concrete composition and corresponding experimental data are reported.

### Example 1

Portland cement: 70%
CSA: 30%
Total binder 400 kg/m³
Water 176 l/m³
Superfluidifying additive 2%
Retardant (Citric acid) 0.3%
Sand 55%
Aggregate 4-8, 45%

| | Spreading | Rc, MPa | Rc, MPs | Rc, MPa |
|---|---|---|---|---|
| a/c | 0 min/30 min | 2 h | 5 h | 10 h |
| 0.44 | 760/700 | 12.65 | 15.70 | 17.55 |

### Example 2

Portland cement: 75%
CSA: 25%
Total binder 400 kg/m³
Water 176 l/m³
Superfluidifying additive 2%
Retardant (Citric acid) 0.3%
Sand 55%
Aggregate 4-8, 45%

| | Spreading | Rc, MPa | Rc, MPs | Rc, MPa |
|---|---|---|---|---|
| a/c | 0 min/30 min | 2 h | 5 h | 10 h |
| 0.44 | 740/720 | 6.45 | 15.8 | 17.30 |

### Example 3

Portland cement: 80%
CSA: 20%
Total binder 400 kg/m³
Water 176 l/m³
Superfluidifying additive 2%
Retardant (Citric acid) 0.3%
Sand 55%
Aggregate 4-8, 45%

| | | | | Rc, |
|---|---|---|---|---|
| | Spreading | Rc, MPa | Rc, MPs | MPa |
| a/c | 0 min/30 min | 2 h | 5 h | 24 h |
| 0.44 | 740/690 | 7.00 | 17.55 | 22.50 |

1. A concrete comprising a binding blend of Portland cement and calcium sulphoaluminate (CSA)-based cement.

2. The concrete according to claim 1, comprising dicalcium silicate (CaO·SiO₂ or C₂S) calcium sulphate in one of the anhydrous, hemihydrate or dihydrate forms, or combinations thereof.

3. The concrete according to claim 1, wherein the ratio by weight between said Portland cement and said calcium sulphoaluminate-based cement varies from 90:10 to 65:35.

4. The concrete according to claim 3, wherein said ratio by weight is equal to 75:25 or equal to 80:20.

5. The concrete according to claim 1, wherein said binding blend has a total weight of between 250-500 kg/m³.

6. The concrete according to claim 1, further comprising one or more additives selected from superfluidifying agents, hyperfluidifying agents, for the summer or winter season, retardants, accelerating agents, deaerating agents, expanding agents and shrinkage reducers.

7. The concrete according to claim 1, further comprising citric acid.

8. The concrete according to claim 7, wherein said citric acid is present in an amount of between 0.1% and 0.5%, by weight with respect to the total weight of the binding blend.

9. The concrete according to claim 1, further comprising a blend of aggregates, wherein said blend of aggregates comprises big aggregate in an amount equal to 45% by weight with respect to the total weight of the blend of aggregates, and sand in an amount equal to 55% by weight with respect to the total weight of the blend of aggregates.

10. The concrete according to claim 1, further comprising water in amount of between 140-190 l/m³.

11. The concrete according to claim 1, characterized by a flowing time t₅₀₀ of between 10 and 15 seconds and by an expansion diameter comprised of 550 and 750 mm.

12. The concrete according to claim 1, wherein said concrete has a composition so as to guarantee a workability of at least thirty minutes, and a resistance equal to at least 5 MPa within two hours from casting.

13. A process for the production of concrete of claim 1, comprising a passage of hydrating a blend of Portland cement and calcium sulphoaluminate (CSA)-based cement.

14. The process according to claim 13, comprising the use of an automatic concreting system, provided with planetary mixer wherein the mixing system is obtained by the action of three central arms on one star and a peripheral scraping.

15. The process according to claim 13, wherein said concreting system is provided with electro-electronic apparatus for commanding and controlling manually and automatically, even remotely, the system.

16. (canceled)

17. (canceled)

18. A process for implementing the foundation of railway slabs comprising:
preparation of concrete as defined in claim 1; and
casting of said concrete between the intrados surface of said slabs and a platform plane.

19. The concrete according to claim 5, wherein said binding blend has a total weight equal to 400 kg/m³.

20. The concrete according to claim 8, wherein said citric acid is present in an amount of 0.3% by weight with respect to the total weight of the binding blend.
